(19) United States
(12) Patent Application Publication
(10) Pub. No.: US 2026/0021852 A1
(43) Pub. Date: Jan. 22, 2026

(54) SYSTEM AND METHOD OF CONTROLLING VEHICLE

(71) Applicants: Hyundai Motor Company, Seoul (KR); Kia Corporation, Seoul (KR)

(72) Inventors: Hong Heui LEE, Hwaseong-si (KR); Seung Hwan LEE, Hwaseong-si (KR); Dong Ha KIM, Hwaseong-si (KR); Jin Young YOON, Hwaseong-si (KR); Eun Soo PARK, Hwaseong-si (KR)

(21) Appl. No.: 18/958,259

(22) Filed: Nov. 25, 2024

(30) Foreign Application Priority Data
Jul. 22, 2024 (KR) 10-2024-0096178

(51) Int. Cl. B62D 35/00

(52) U.S. Cl. CPC B62D 35/007; B62D 35/005

(57) ABSTRACT

A system for controlling a vehicle includes a plurality of active aerodynamic components installed on the vehicle, and a controller configured to control operation of the plurality of active aerodynamic components depending on a selected driving mode of the vehicle.

### CROSS-REFERENCE TO RELATED APPLICATION

This application claims under 35 U.S.C. § 119(a) the benefit of priority to Korean Patent Application No. 10-2024-0096178, filed on Jul. 22, 2024, the entire contents of which are incorporated herein by reference.

### TECHNICAL FIELD

The present disclosure relates to controlling a vehicle. More particularly, the present disclosure relates to controlling active aerodynamic components of a vehicle.

### BACKGROUND

When an object moves through the air, it experiences aerodynamic forces due to its motion relative to the air. These forces include lift, which acts perpendicular to the direction of motion, and drag, which acts parallel to the direction of motion.

Similarly, aerodynamic forces affect a vehicle in motion due to its relative movement through the air. Enhancing a vehicle's aerodynamics can improve its stability and increase both electric power and fuel efficiency, making it a critical consideration in vehicle design.

Recently, active aerodynamic components that adjust based on a vehicle's driving speed have been introduced to enhance performance.

### SUMMARY

The present disclosure is directed to a system for controlling a vehicle, the system including a plurality of active aerodynamic components installed on the vehicle, and a controller configured to control operation of the plurality of active aerodynamic components based on a selected driving mode of the vehicle.

The present disclosure is also directed to a method of controlling a vehicle, the method including detecting, by a controller, a driving mode of the vehicle, and controlling, by the controller, operation of active aerodynamic components based on the detected driving mode of the vehicle.

### BRIEF DESCRIPTION OF THE DRAWINGS

FIG. 1 is a diagram illustrating an example of a vehicle.

FIG. 2A is a diagram illustrating an example of an active air flap of active aerodynamic components when the active air flap is in a closed position.

FIG. 2B is a diagram illustrating an example of the active air flap of the active aerodynamic components when the active air flap is in an open position.

FIG. 3A is a diagram illustrating an example of an active air skirt of the active aerodynamic components when the active air skirt is in a retracted position.

FIG. 3B is a diagram illustrating an example of the active air skirt of the active aerodynamic components when the active air skirt is in a deployed position.

FIG. 4A is a diagram illustrating an example of an active rear spoiler of the active aerodynamic components when the active rear spoiler is in a retracted position.

FIG. 4B is a diagram illustrating an example of the active rear spoiler of the active aerodynamic components when the active rear spoiler is in a deployed position.

FIG. 5A is a diagram illustrating an example of an active rear bumper diffuser of the active aerodynamic components when the active rear bumper diffuser is in a retracted position.

FIG. 5B is a diagram illustrating an example of the active rear bumper diffuser of the active aerodynamic components when the active rear bumper diffuser is in a deployed position.

FIG. 6 is a block diagram illustrating an example of a system for controlling a vehicle.

FIG. 7 is a flowchart of an example of a method of controlling a vehicle.

### DETAILED DESCRIPTION

Hereinafter, the present disclosure will be described in detail with reference to the accompanying drawings.

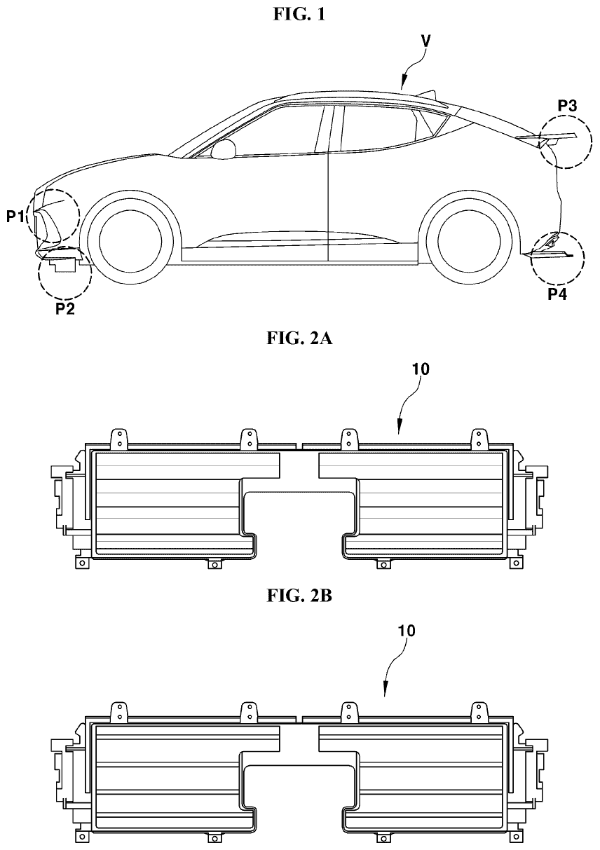

FIG. 1 is a diagram illustrating an example of a vehicle. FIG. 2A is a diagram illustrating an example of an active air flap of active aerodynamic components when the active air flap is in a closed position. FIG. 2B is a diagram illustrating an example of the active air flap of the active aerodynamic components when the active air flap is in an open position.

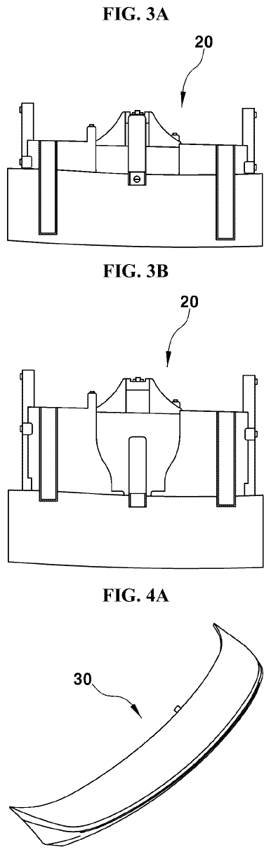

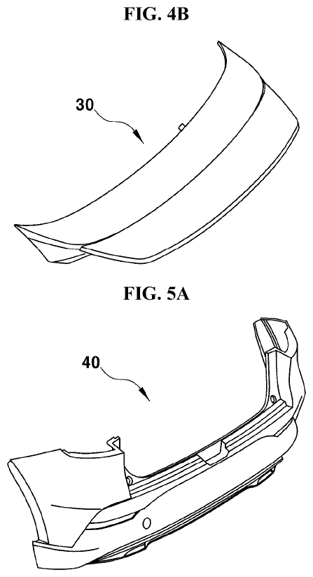

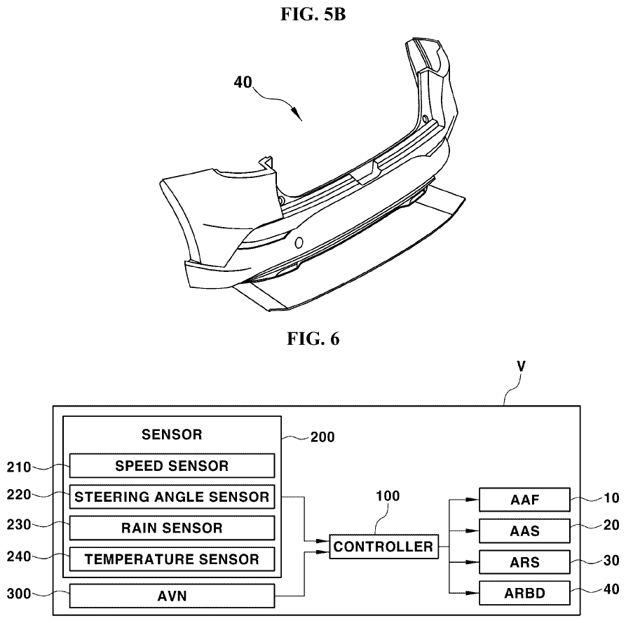

FIG. 3A is a diagram illustrating an example of an active air skirt of the active aerodynamic components when the active air skirt is in a retracted position. FIG. 3B is a diagram illustrating an example of the active air skirt of the active aerodynamic components when the active air skirt is in a deployed position. FIG. 4A is a diagram illustrating an example of an active rear spoiler of the active aerodynamic components when the active rear spoiler is in a retracted position. FIG. 4B is a diagram illustrating an example of the active rear spoiler of the active aerodynamic components when the active rear spoiler is in a deployed position. FIG. 5A is a diagram illustrating an example of an active rear bumper diffuser of the active aerodynamic components when the active rear bumper diffuser is in a retracted position. FIG. 5B is a diagram illustrating an example of the active rear bumper diffuser of the active aerodynamic components when the active rear bumper diffuser is in a deployed position. FIG. 6 is a block diagram illustrating an example of a system for controlling a vehicle.

A vehicle V can include active aerodynamic components 10, 20, 30, and 40. In some implementations, the active aerodynamic components 10, 20, 30, and 40 can include an active air flap (AAF) 10, an active air skirt (AAS) 20, an active rear spoiler (ARS) 30, and an active rear bumper diffuser (ARBD) 40. In some implementations, the active aerodynamic components 10, 20, 30, and 40 can include an arbitrary combination of the AAFs 10, the AASs 20, the ARS 30, or the ARBD 40. In some implementations, the active aerodynamic components 10, 20, 30, and 40 can include all of the AAF 10, the AAS 20, the ARS 30, and the ARBD 40.

The AAF 10 can control the flow of air for cooling components in the vehicle V. In some implementations, the AAF 10 can be mounted at the front end of the vehicle V (a part P1 in FIG. 1). As shown in FIGS. 2A and 2B, the AAF 10 can be closed or opened as needed. At the open position of the AAF 10, air may flow into a front compartment of the vehicle V. At the closed position of the AAF 10, the air flowing into the front compartment of the vehicle V can be substantially blocked. Further, the opening amount of the AAF 10 can be adjusted between its fully open and fully closed positions. For example, only a portion of the AAF 10 can be in the open position. By way of further example, the entire AAF 10 can be adjusted uniformly to various degrees of openness. This adjustment can control the amount of air supplied to the vehicle V for cooling, depending on the specific position of the AAF 10.

As shown in FIGS. 3A and 3B, the AAS 20 can control the flow of air in front of wheels of the vehicle V or at the lower part of the front of the vehicle V (a part P2 in FIG. 1). The AAS 20 can extended and deploy downward from the vehicle V toward the ground, and can retract from the deployed position back into the vehicle V. The amount of air flowing toward tires through the lower part of a bumper of the vehicle V can be adjusted by controlling the AAS 20.

As shown in FIGS. 4A and 4B, the ARS 30 can adjust the flow of air at the upper part or the middle part of the rear of the vehicle V (a part P3 in FIG. 1). The ARS 30 can be retractable. At the deployed position of the ARS 30, the ARS 30 can extend toward the outside of the vehicle V. At the retracted position of the ARS 30, the ARS 30 can be received at the vehicle V.

As shown in FIGS. 5A and 5B, the ARBD 40 can control the flow of air at the lower part of the rear of the vehicle V (a part P4 in FIG. 1). The ARBD 40 can be retractable. At the deployed position of the ARBD 40, the ARBD 40 can extend toward the outside of the vehicle V, and, at the retracted position of the ARBD 40, the ARBD 40 can be received at the vehicle V.

As shown in FIG. 6, the vehicle V can include one or more sensors 200. The sensors 200 can include a sensor configured to sense the driving information of the vehicle V. As a non-limiting example, the sensors 200 can include a speed sensor 210 configured to detect the speed of the vehicle V. In some implementations, the sensors 200 can include a steering angle sensor 220 configured to detect the steering angle of the vehicle V. In addition, the sensors 200 can include an environmental sensor configured to detect an environment surrounding the vehicle V. For example, the environmental sensor can include a lidar sensor, a radar sensor, or a camera. In some implementations, the sensors 200 can include a rain sensor 230 configured to detect whether it is raining. In some implementations, the sensors 200 can include a temperature sensor 240 configured to detect an ambient temperature. The types of the listed sensors 200 are exemplary, and the sensors 200 may further include other sensors configured to detect the driving information or the surrounding environment of the vehicle V.

The vehicle V can include an audio, video, and navigation (AVN) device 300. The AVN device 300 can exchange information with passengers of the vehicle V both visually and audibly. For example, the AVN device 300 can display an image around the vehicle V, captured by the environmental sensor provided in the vehicle V. As a non-limiting example, the AVN device 300 can provide a navigation function of providing route information to the destination of the vehicle V.

The vehicle V can include a controller 100. The controller 100 can be configured to control operation of the active aerodynamic components. In some implementation, the controller 100 can adjust the opening amount or position of the AAF 10. In some implementation, the controller 100 can retract or deploy at least one of the AAS 20, the ARS 30, or the ARBD 40.

The controller 100 can be configured to communicate with at least one of the sensors 200 or the AVN device 300. The controller 100 can acquire information detected by the sensors 200. Further, the controller 100 can acquire information from the AVN device 300.

The controller 100 can control the operation of the active aerodynamic components 10, 20, 30, and 40 based on information provided by at least one of the sensors 200 or the AVN device 300.

In addition, the controller 100 can detect the driving mode of the vehicle V. The driving mode can be selected by a driver of the vehicle V. For example, an operating unit, such as a knob or a button, for selecting the driving mode can be provided in the vehicle V.

A plurality of different driving modes can be provided, allowing the driving characteristics of the vehicle V to change based on the selected mode. In some implementation, the driving modes can include a normal mode, an eco-mode, and a sport mode that are preset in the vehicle V. The normal mode can serve as the default setting, where the vehicle's driving characteristics can be adjusted for a comfortable ride. In the eco-mode, the driving characteristics of the vehicle V can be adjusted to prioritize fuel or electric power efficiency. In the sport mode, the driving characteristics of the vehicle V are focused on driving enjoyment.

According to the present disclosure, the controller 100 can be configured to control the operation of the active aerodynamic components 10, 20, 30, and 40 based on the selected driving mode. Further, the controller 100 can be configured to control the operation of the active aerodynamic components 10, 20, 30, and 40 based on the driving speed of the vehicle V in each driving mode. According to the present disclosure, the operation of the active aerodynamic components 10, 20, 30, and 40 can be coordinated to achieve optimal efficiency for each driving mode of the vehicle V.

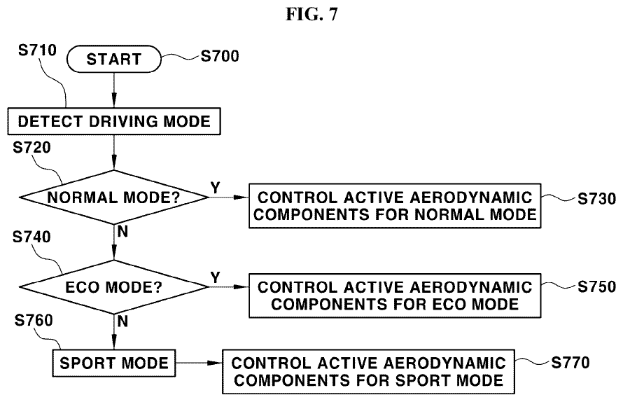

Referring to FIG. 7, control of the vehicle V can start at Operation S700. The controller 100 can be configured to detect the driving mode of the vehicle V, which is currently selected, at Operation S710.

First, the controller 100 can determine whether the currently selected driving mode is the normal mode at Operation S720. If the currently selected driving mode is the normal mode, the controller 100 can control the active aerodynamic components 10, 20, 30, and 40 for the normal mode at Operation S730.

In some implementations, the controller 100 can divide a low-speed section and a high-speed section from each other in the normal mode and control operation of the active aerodynamic components 10, 20, 30, and 40 differently in each section. In the low-speed section, e.g., 0 to 80 kilometers per hour, the active aerodynamic components 10, 20, 30, and 40 can be controlled in consideration of improvement in the driving performance and aerodynamic performance of the vehicle V. In the high-speed section, e.g., 80 or more kilometers per hour, the active aerodynamic components 10, 20, 30, and 40 can be controlled in consideration of improvement in the aerodynamic performance of the vehicle.

In some implementations, in a speed range of 0 to 20 kilometers per hour in the low-speed section of the vehicle V, the controller 100 can set the operation ranges of the active aerodynamic components 10, 20, 30, and 40 in detail to thereby optimize the aerodynamic performance improvement effect. For example, the controller 100 completely can open the AAF 10 to reduce temperatures of electrical components of a battery and a brake. In addition, the controller 100 can retract the AAS 20 and the ARBD 40 (i.e., 0% deployment) to prevent interference with bumps or obstacles under normal driving conditions. Considering that the eddy improvement effect is low during low-speed driving, the controller 100 can also retract the ARS 30 (i.e., 0% deployment).

In some implementations, in a speed range of 20 to 40 kilometers per hour in the low-speed section of the vehicle V, the controller 100 can partially open the AAF 10 to reduce temperatures of the electrical components of the battery and the brake and improve aerodynamics. For example, the opening amount of the AAF 10 can be 75%. Further, the controller 100 can retract the AAS 20 and the ARBD 40 (i.e., 0% deployment) to prevent interference with bumps or obstacles under normal driving conditions. Considering that the eddy improvement effect is low during low-speed driving, the controller 100 can also retract the ARS 30 (i.e., 0% deployment).

In some implementations, in a speed range of 40 to 60 kilometers per hour in the low-speed section of the vehicle V, the controller 100 can partially open the AAF 10 to reduce temperatures of the electrical components of the battery and the brake and improve aerodynamics. For example, the opening amount of the AAF 10 can be 50%. Further, in this speed range, the controller 100 can also partially deploy the AAS 20 and the ARBD 40 (e.g., 25% deployment) based on the speed of the vehicle V. In this speed range, the controller 100 can also partially deploy the ARS 30 (e.g., 25% deployment) based on that the influence of an eddy is low.

In some implementations, in a speed range of 60 to 80 kilometers per hour in the low-speed section of the vehicle V, the controller 100 can partially open the AAF 10 to reduce temperatures of the electrical components of the battery and the brake and improve aerodynamics. For example, the opening amount of the AAF 10 can be 25%. Further, in this speed range, the controller 100 can also partially deploy the AAS 20 and the ARBD 40 (e.g., 50% deployment) considering the speed. In this speed range, the controller 100 can also partially deploy the ARS 30 (e.g., 50% deployment) based on that the influence of an eddy is low.

In some implementations, in the high-speed section of the vehicle V (i.e., 80 or more kilometers per hour), the controller 100 can provide the active aerodynamic components 10, 20, 30, and 40 in an aerodynamic improvement mode to thereby optimize the aerodynamic performance improvement effect. The controller 100 can completely close the AAF 10 to improve aerodynamics. For example, the opening amount of the AAF 10 can be 0%. In this speed range, the controller 100 can also partially deploy the AAS 20 and the ARBD 40 (e.g., 75% deployment) considering the high speed. In this speed range, the controller 100 can also partially deploy the ARS 30 (e.g., 75% deployment) based on that the influence of an eddy is high.

In some implementations, when a momentary speed change occurs in a speed range of 30 to 60 kilometers per hour, the controller 100 can control the operation of the active aerodynamic components 10, 20, 30, and 40. If sudden deceleration of the vehicle V occurs, the controller 100 can control the operation of the active aerodynamic components 10, 20, 30, and 40 in a direction of increasing resistance to improve steering force. For example, if sudden deceleration occurs from a speed range of 40 to 80 kilometers per hour to a speed range of 0 to 40 kilometers per hour, the controller 100 can change the opening amount of the AAF 10 from 25% to 75%. In addition, the controller 100 can reduce the deployment amounts of the AAS 20, the ARS 30, and the ARBD 40 from 50% to 0%. If sudden acceleration of the vehicle occurs, the controller 100 can control the operation of the active aerodynamic components 10, 20, 30, and 40 in a direction of reducing resistance to improve aerodynamics. For example, if sudden acceleration occurs from a speed range of 0 to 40 kilometers per hour to a speed range of 40 to 80 kilometers per hour, the controller 100 can change the opening amount of the AAF 10 from 75% to 25%. In addition, the controller 100 can increase the deployment amounts of the AAS 20, the ARS 30, and the ARBD 40 from 0% to 50%.

In some implementations, in the high-speed section of the vehicle V (e.g., 80 or more kilometers per hour), the controller 100 can set the operation ranges of the active aerodynamic components 10, 20, 30, and 40 in detail to thereby optimize the aerodynamic performance improvement effect.

In a speed range of 80 to 100 kilometers per hour in the high-speed section of the vehicle V, the controller 100 can completely close the AAF 10 to improve aerodynamics. For example, the opening amount of the AAF 10 can be 0%. In addition, in this speed range, the controller 100 can also partially deploy the AAS 20 and the ARBD 40 (e.g., 75% deployment) considering the high speed. In this speed range, the controller 100 can also partially deploy the ARS 30 (e.g., 75% deployment) based on that the influence of an eddy is high.

In a speed range of 100 or more kilometers per hour in the high-speed section of the vehicle V, the controller 100 can completely close the AAF 10 to improve aerodynamics. For example, the opening amount of the AAF 10 can be 0%. In this speed range, the controller 100 can also completely deploy the AAS 20 and the ARBD 40 (i.e., 100% deployment) considering the high speed. In this speed range, the controller 100 can also completely deploy the ARS 30 (i.e., 100% deployment) based on that the influence of an eddy is high.

In a speed range of 160 or more kilometers per hour in the high-speed section of the vehicle V, the controller 100 can control the active aerodynamic components 10, 20, 30, and 40 to adjust cooling performance and resistance in consideration of safety of the vehicle V. In this range, the controller 100 can also completely open the AAF 10 (to the opening amount of 100%). The controller 100 can completely deploy the AAS 20 and the ARBD 40 (e.g., 100% deployment) considering the high speed in this range. Since this range is a section in which the influence of an eddy is high, the controller 100 can also completely deploy the ARS 30 (e.g., 100% deployment).

In some implementations, if a momentary speed change occurs in a section of a speed range of 100 to 160 kilometers per hour, the controller 100 can control the operation of the active aerodynamic components 10, 20, 30, and 40. If sudden deceleration of the vehicle V occurs, the controller 100 can control the operation of the active aerodynamic components 10, 20, 30, and 40 in the direction of increasing resistance to improve steering force. For example, if sudden deceleration occurs from a speed range of 140 to 160 kilometers per hour to a speed range of 100 to 120 kilometers per hour, the controller 100 can change the opening amount of the AAF 10 from 0% to 25%. In addition, the controller 100 can reduce the deployment amounts of the AAS 20, the ARS 30, and the ARBD 40 from 100% to 75%. If sudden acceleration of the vehicle occurs, the controller 100 can control the operation of the active aerodynamic components 10, 20, 30, and 40 in the direction of reducing resistance to improve aerodynamics.

If the current driving mode is not the normal mode, the controller 100 can determine whether the current driving mode is the eco-mode at Operation S740. If the current driving mode corresponds to the eco-mode, the controller 100 can control the active aerodynamic components 10, 20, 30, and 40 for the eco-mode at S750.

In some implementations, the controller 100 can control the operation of active aerodynamic components 10, 20, 30, and 40 to maximize the aerodynamic improvement effect under fuel-efficient driving conditions focused on low speeds in the eco-mode. Particularly, the controller 100 can divide a low-speed section and a high-speed section from each other in the eco-mode and control the operation of the active aerodynamic components 10, 20, 30, and 40 differently in each section. In the low-speed section (e.g., 100 or less kilometers per hour), the active aerodynamic components 10, 20, 30, and 40 can be controlled in consideration of improvement in fuel efficiency, and in the high-speed section (e.g., 100 or more kilometers per hour), the eco mode may be discontinued and the active aerodynamic components 10, 20, 30, and 40 can be controlled to improve the aerodynamic performance as in the normal mode.

In some implementations, in a speed range of 0 to 20 kilometers per hour in the low-speed section of the vehicle V, the controller 100 can completely close the AAF 10 to improve fuel efficiency through aerodynamic improvement rather than cooling the electrical components of the battery and the brake. In addition, the controller 100 can retract the AAS 20 and the ARBD 40 (i.e., 0% deployment) to prevent the vehicle V from being caught on bumps or obstacles under normal driving conditions. The controller 100 can also retract the ARS 30 (i.e., 0% deployment) based on that the eddy improvement effect is low during low-speed driving.

In some implementations, in a speed range of 20 to 60 kilometers per hour in the low-speed section of the vehicle V, the controller 100 can completely close the AAF 10 to improve fuel efficiency through aerodynamic improvement rather than cooling the electrical components of the battery and the brake. In addition, the controller 100 can partially deploy the AAS 20 and the ARBD 40 (e.g., 25% deployment) considering the speed in this range. The controller 100 can also partially deploy the ARS 30 (e.g., 25% deployment) based on that the eddy improvement effect is low.

In some implementations, in a speed range of 60 to 80 kilometers per hour in the low-speed section of the vehicle V, the controller 100 can completely close the AAF 10 to improve fuel efficiency through aerodynamic improvement rather than cooling the electrical components of the battery and the brake. In addition, the controller 100 can partially deploy the AAS 20 and the ARBD 40 (e.g., 75% deployment) considering the speed in this speed range. The controller 100 can also partially deploy the ARS 30 (e.g., 75% deployment) based on that the influence of an eddy is low in this speed range.

In some implementations, when a momentary speed change occurs in a speed range of 20 to 60 kilometers per hour, the controller 100 can control the operation of the active aerodynamic components 10, 20, 30, and 40. If sudden deceleration of the vehicle V occurs, the controller 100 can control the operation of the active aerodynamic components 10, 20, 30, and 40 in the direction of increasing resistance to improve steering force. For example, if sudden deceleration occurs from a speed range of 40 to 80 kilometers per hour to a speed range of 0 to 40 kilometers per hour, the controller 100 can change the opening amount of the AAF 10 from 0% to 50%. In addition, the controller 100 can reduce the deployment amounts of the AAS 20, the ARS 30, and the ARBD 40 from 50% to 0%. If sudden acceleration of the vehicle occurs, the controller 100 can control the operation of the active aerodynamic components 10, 20, 30, and 40 in the direction of reducing resistance to improve aerodynamics. For example, if sudden acceleration occurs from a speed range of 0 to 40 kilometers per hour to a speed range of 40 to 80 kilometers per hour, the controller 100 can keep the AAF 10 closed while increasing the deployment amounts of the AAS 20, the ARS 30, and the ARBD 40 from 0% to 50%.

In some implementations, in the high-speed section (e.g., 100 or more kilometers per hour), the controller 100 can control the active aerodynamic components 10, 20, 30, and 40 to improve aerodynamics as in the normal mode. The controller 100 can completely close the AAF 10 to improve aerodynamics. In addition, in this speed range, the controller 100 can completely deploy the AAS 20 and the ARBD 40 (e.g., 100% deployment) considering the high speed. In this speed range, the controller 100 can completely deploy the ARS 30 (i.e., 100% deployment) based on that the influence of an eddy is high.

In a speed range of 160 or more kilometers per hour in the high-speed section of the vehicle V, the controller 100 can control the active aerodynamic components 10, 20, 30, and 40 to thereby increase cooling performance and resistance in consideration of safety of the vehicle V. In this range, the controller 100 can completely open the AAF 10 (to the opening amount of 100%). The controller 100 can completely deploy the AAS 20 and the ARBD 40 (i.e., 100% deployment) considering the high speed in this range. Since this range is a section in which the influence of an eddy is high, the controller 100 can also completely deploy the ARS 30 (i.e., 100% deployment).

In some implementations, if a momentary speed change occurs in a section of a speed range of 100 to 160 kilometers per hour, the controller 100 can control the operation of the active aerodynamic components 10, 20, 30, and 40. If sudden deceleration of the vehicle V occurs, the controller 100 can control the operation of the active aerodynamic components 10, 20, 30, and 40 in the direction of increasing resistance to improve steering force. For example, if sudden deceleration occurs from a speed range of 140 to 160 kilometers per hour to a speed range of 100 to 120 kilometers per hour, the controller 100 can change the opening amount of the AAF 10 from 0% to 25%. In addition, the controller 100 can reduce the deployment amounts of the AAS 20 and the ARBD 40 from 100% to 75% and maintain the 100% deployment state of the ARS 30. If sudden acceleration of the vehicle occurs, the controller 100 can control the operation of the active aerodynamic components 10, 20, 30, and 40 in the direction of reducing resistance to improve aerodynamics.

If the current driving mode is not the eco-mode (No at Operation S740), the controller 100 can determine the current driving mode as the sport mode at Operation S760. Accordingly, the controller 100 can perform control of the active aerodynamic components 10, 20, 30, and 40 for the sport mode at Operation S770.

In some implementations, the controller 100 can control the active aerodynamic components 10, 20, 30, and 40 to improve aerodynamics regardless of speed to thereby implement high-speed and acceleration conditions in the sport mode. Specifically, the active aerodynamic components 10, 20, 30, and 40 can be controlled to improve aerodynamics at a speed range of 40 or more kilometers per hour.

For example, in a speed section (for example, 40 to 160 kilometers per hour), the controller 100 can completely close the AAF 10 to improve aerodynamics. In addition, the controller 100 can completely deploy the AAS 20 and the ARBD 40 (e.g., 100% deployment) considering the high speed in this speed range. The controller 100 can also completely deploy the ARS 30 (e.g., 100% deployment) based on that the influence of an eddy is high in this speed range.

In a speed range of 160 or more kilometers per hour, the controller 100 can control the active aerodynamic components 10, 20, 30, and 40 to increase cooling performance and resistance in consideration of safety of the vehicle V. In this range, the controller 100 can completely open the AAF 10 (to the opening amount of 100%) to implement aerodynamics. The controller 100 can completely deploy the AAS 20 and the ARBD 40 (i.e., 100% deployment) considering the high speed in this range. Since this range is a section in which the influence of an eddy is high, the controller 100 can also completely deploy the ARS 30 (i.e., 100% deployment).

In some implementations, if a momentary speed change occurs in a section of a speed range of 40 to 160 kilometers per hour, the controller 100 can control the operation of the active aerodynamic components 10, 20, 30, and 40. If sudden deceleration of the vehicle V occurs, the controller 100 can control the operation of the active aerodynamic components 10, 20, 30, and 40 in the direction of increasing resistance to improve steering force. For example, if sudden deceleration occurs from a speed range of 40 to 160 kilometers per hour to a speed of 40 kilometers per hour within a short period of time, e.g., within 2 seconds, the controller 100 can change the opening amount of the AAF 10 from 0% to 100%. In addition, the controller 100 can reduce the deployment amounts of the AAS 20 and the ARBD 40 from 100% to 0%. If sudden acceleration of the vehicle occurs, the controller 100 can control the operation of the active aerodynamic components 10, 20, 30, and 40 in the direction of reducing resistance to improve aerodynamics.

The controller 100 can adjust the states of the active aerodynamic components 10, 20, 30, and 40 under predetermined conditions. For example, when information regarding a sudden deceleration factor, such as a speed limit zone or an obstacle, is collected by the environmental sensor, such as a camera of the vehicle V or a navigation device, the controller 100 can decelerate the vehicle V to a certain speed to terminate control of the active aerodynamic components 10, 20, 30, and 40 for aerodynamic improvement. When the aerodynamic improvement mode is terminated, the AAS 20, the ARS 30, and the ARBD 40 can be all retracted, and the AAF 10 can be completely opened. By way of further example, when the vehicle V enters a sharp turn section, the vehicle V can be decelerated, and the effect of the aerodynamic improvement mode can be reduced. When information that the vehicle V has entered a sharp turn section by the AVN device 300 or the steering angle sensor 220 is collected, the controller 100 can open the AAF 10 located in the turning direction of the vehicle V to implement a steering improvement mode. For example, in case of a left turn of the vehicle V, only the left portion of the AAF 10 can be opened, and in case of a right turn of the vehicle V, only the right portion of the AAF 10 can be opened. In some implementations, the controller 100 can collect weather information by the rain sensor 230, the temperature sensor 240, the environmental sensor, or the AVN device 300. When heavy rain falls while the aerodynamic improvement mode is executed, water may penetrate into the vehicle V through the active aerodynamic components 10, 20, 30, and 40. Under low temperature conditions or in case of heavy snow, moving systems for the active aerodynamic components 10, 20, 30, and 40 may be overloaded due to freezing or the weight of snow. Accordingly, the controller 100 can terminate control of the active aerodynamic components 10, 20, 30, and 40 for aerodynamic improvement based on the weather information. When the aerodynamic improvement mode is terminated, the controller 100 can retract all of the AAS 20, the ARS 30, and the ARBD 40 and can completely open the AAF 10.

What is claimed is:

1. A system for controlling a vehicle, comprising:
a plurality of active aerodynamic components disposed at the vehicle; and
a controller configured to control operation of the plurality of active aerodynamic components based on a driving mode of the vehicle that is selected from among a plurality of driving modes.

2. The system of claim 1, wherein the controller is configured to control the operation of the plurality of active aerodynamic components based on a speed of the vehicle in each driving mode of the plurality of driving modes.

3. The system of claim 1, wherein the plurality of active aerodynamic components comprises an active air flap, an active air skirt, an active rear spoiler, and an active rear bumper diffuser.

4. The system of claim 3, wherein:
the active air flap is disposed at a front end of the vehicle and configured to, based on being opened, allow fluid communication between an interior and an exterior of the vehicle and, based on being closed, block the fluid communication between the interior and the exterior of the vehicle, an opening degree of the active air flap being adjustable between open and closed positions,
the active air skirt is disposed in front of front wheels of the vehicle and configured to deploy toward ground or retract into the vehicle;
the active rear spoiler is disposed at an upper or middle part of a rear of the vehicle and configured to deploy toward an outside of the vehicle or retract into the vehicle, and
the active rear diffuser is disposed at a lower part of the rear of the vehicle and configured to deploy toward the outside of the vehicle or retract into the vehicle.

5. The system of claim 3, wherein, based on the selected driving mode being a normal mode, the controller is configured to:
in a first speed range, open the active air flap and retract the active air skirt, the active rear spoiler, and the active rear bumper diffuser, and
in a second speed range, close the active air flap and deploy the active air skirt, the active rear spoiler, and the active rear bumper diffuser, and
wherein the first speed range is a speed range less than the second speed range.

6. The system of claim 5, wherein the controller is configured to increase a closed area of the active air flap and increase deployment degrees of the active air skirt, the active rear spoiler, and the active rear bumper diffuser, as the speed increases in each speed range.

7. The system of claim 5, wherein the controller is configured to, in a third speed range, fully open the active air flap and fully deploy the active air skirt, the active rear spoiler, and the active rear bumper diffuser, and
wherein the third speed range is a speed range greater than the second speed range.

8. The system of claim 5, wherein the controller is configured to control the operation of the plurality of active aerodynamic components in response to occurrence of sudden deceleration or sudden acceleration of the vehicle in the second speed range.

9. The system of claim 3, wherein, based on the selected driving mode being an eco-mode, the controller is configured to:
in a first speed range, close the active air flap and retract the active air skirt, the active rear spoiler, and the active rear bumper diffuser, and
in a second speed range, close the active air flap and deploy the active air skirt, the active rear spoiler, and the active rear bumper diffuser, and
wherein the first speed range is a speed range less than the second speed range.

10. The system of claim 9, wherein the controller is configured to increase deployment degrees of the active air skirt, the active rear spoiler, and the active rear bumper diffuser, as the speed increases in the first speed range.

11. The system of claim 9, wherein the controller is configured to, in a third speed range, fully open the active air flap and fully deploy the active air skirt, the active rear spoiler, and the active rear bumper diffuser, and
wherein the third speed range is a speed range greater than the second speed range.

12. The system of claim 3, wherein, based on the driving mode being a sport mode, the controller is configured to, in a first speed range, close the active air flap and deploy the active air skirt, the active rear spoiler, and the active rear bumper diffuser.

13. The system of claim 12, wherein the controller is configured to, in a second speed range, fully open the active air flap and deploy the active air skirt, the active rear spoiler, and the active rear bumper diffuser.

14. The system of claim 3, wherein the controller is configured to, based on (i) the vehicle entering into a speed limit zone or (ii) presence of an obstacle to the vehicle, open the active air flap and retract the active air skirt, the active rear spoiler, and the active rear bumper diffuser.

15. The system of claim 3, wherein the controller is configured to, based on the vehicle entering into a turning zone, open the active air flap that is located in a same direction as a turning direction of the vehicle.

16. The system of claim 3, wherein the controller is configured to, based on the vehicle being in a low temperature, open the active air flap and retract the active air skirt, the active rear spoiler, and the active rear bumper diffuser of the plurality of active aerodynamic components.

17. A method of controlling a vehicle, comprising:
detecting, by a controller, a driving mode of the vehicle; and
controlling, by the controller, operation of a plurality of active aerodynamic components based on the detected driving mode of the vehicle.

18. The method of claim 17, wherein:
the driving mode comprises one of a normal mode, an eco-mode, or a sport mode, and
controlling the operation of the plurality of active aerodynamic components comprises controlling the operation of the plurality of active aerodynamic components based on a speed of the vehicle in each driving mode.

19. The method of claim 17, wherein the plurality of active aerodynamic components comprise an active air flap, an active air skirt, an active rear spoiler, and an active rear bumper diffuser.

20. The method of claim 19, wherein:
the active air flap is disposed at a front end of the vehicle and configured to, based on being opened, allow fluid communication between an interior and an exterior of the vehicle and, based on being opened, block the fluid communication between the interior and the exterior of the vehicle, an opening degree of the active air flap being adjustable between open and closed positions,
the active air skirt is disposed in front of front wheels of the vehicle and configured to deploy toward ground or retract into the vehicle,
the active rear spoiler is disposed at an upper or middle part of a rear of the vehicle and configured to deploy toward an outside of the vehicle or retract into the vehicle, and
the active rear diffuser is disposed at a lower part of the rear of the vehicle and configured to deploy toward the outside of the vehicle or retract into the vehicle.
